(19) United States
(12) Patent Application Publication
(10) Pub. No.: US 2026/0317527 A1
(43) Pub. Date: Oct. 15, 2026

(54) WATER-SOLUBLE ECO-FRIENDLY BIOPLASTIC GRANULES AND AN EXTRUSION METHOD OF GRANULE PRODUCTION

(71) Applicant: EKOLOST ORGANIK ÜRÜNLER SANAYI VE TICARET ANONIM SIRKETI, Kocaeli (TR)

(72) Inventors: Berk ÖZYILMAZ, Istanbul (TR); Ebrahim YAGHOUBI, Kocaeli (TR)

(21) Appl. No.: 18/848,083

(22) PCT Filed: Dec. 22, 2023
(86) PCT No.: PCT/TR2023/051664

§ 371 Date: Sep. 17, 2024

(51) Int. Cl. C08L 29/04; B29B 9/06; B29K 29/00; C08J 3/20; C08J 5/18; C08K 5/053; C08K 5/09; C08K 5/13

(52) U.S. Cl. CPC C08L 29/04; C08J 3/203; C08J 5/18; C08K 5/053; C08K 5/09; C08K 5/13; B29B 9/06; B29K 2029/04; B29K 2995/0062; C08J 2329/04; C08J 2401/02; C08J 2405/00; C08J 2497/00; C08L 2201/06; C08L 2203/16; C08L 2205/025; C08L 2205/035

(57) ABSTRACT

Disclosed is a water-soluble bioplastic (WSBP) composed of polyvinyl alcohol (PVA), carboxymethyl chitosan (CMC), nanocrystalline cellulose (NCC), mannitol, lignin, ferulic acid, stearyl alcohol, and lactic acid and a process of producing this bioplastic material as granules and a resulting thin film.

### FIELD OF THE INVENTION

The present invention pertains to the field of bioplastics, specifically a water-soluble bioplastic (WSBP) composed of polyvinyl alcohol (PVA), carboxymethyl chitosan (CMC), nanocrystalline cellulose (NCC), mannitol, lignin, ferulic acid stearyl alcohol and lactic acid. Furthermore, explains in detail the process of producing this bioplastic material as granules and resulting thin film.

### BACKGROUND OF THE INVENTION

Regarding the mentioned applications of the bioplastic, several drawbacks are worth attention. In the packaging sector, the associated production costs might in some regions, surpass that of traditional plastics, potentially reducing its market competitiveness despite the bioplastic's eco-friendly nature. In agricultural sector, there is an inconsistency in its rate of dissolution; the bioplastic could degrade either too rapidly or sluggishly based on varying environmental conditions. Within the medical domain, although biodegradability usually stands as a strength, situations could arise where unexpected swift degradation impedes optimal drug delivery. Lastly, in the context of environmental cleanup, the material's inherent water solubility presents challenges, particularly in damp settings where it might prematurely dissolve before fulfilling its intended role.

EP3458486B1 relates to the separation of manure in fractions and the treatment of said fractions in order to retrieve useful components to produce manure-derived bioplastic and other manure-derived bioproducts. The invention further relates to a method for producing composite (bio) plastic, and to a method for producing fibre from regenerated manure-derived cellulose.

WO2022167933 (A1) relates to a bioplastic composition comprising at least one seaweed extract in a concentration by weight comprised between 30% and 80% with respect to the weight of the bioplastic composition; water in a concentration by weight comprised between 1% and 30% with respect to the weight of the bioplastic composition; at least four additives present in a total concentration by weight comprised between 20% and 70% with respect to the weight of the bioplastic composition; wherein the additives comprise at least one plasticizer, at least one antimicrobial agent, at least one gelling agent and at least one adjuvant.

A probable technical challenge arising from the applications of this bioplastic is achieving a uniform rate of dissolution or degradation across diverse environments and uses. The breakdown speed of the material can be affected by several factors, including pH levels, temperature, and microbial activities. Tackling this inconsistency is pivotal for the bioplastic's widespread adoption and endorsement across multiple sectors.

### SUMMARY OF THE INVENTION

The proposed invention offers a practical water-soluble bioplastic formula, particularly designed to tackle the technical dilemma of consistent degradation and its related application challenges. By optimizing the proportion of Polyvinyl Alcohol (PVA) and its degree of hydrolysis as well as the quantity of Mannitol, Lactic Acid, and other components, this bioplastic's dissolution rate can be custom-fitted to be dissolved in hot or cold water for diverse applications. Moreover, with the integration of Nanocrystalline Cellulose (NCC) and Stearyl Alcohol, the formula improves the bioplastic's mechanical robustness, expanding its applicability without sacrificing its timely decomposition. It needs to be taken into consideration that the environmental footprint of this bioplastic is minimal, as it degrades without depositing hazardous materials and residues, setting it apart from conventional plastics. Additionally, the inclusion of Carboxymethyl chitosan (CMC) and Ferulic Acid contributes to the bioplastic with antimicrobial properties, curbing the chance of microbial degradation and amplifying its efficacy for specific uses. Finally, by slight alteration of portion of components in the formula, the bioplastic's optical attributes, such as transparency or opacity, can be adjusted, ensuring its adaptability for tasks necessitating the application of either translucent or transparent materials.

Polyvinyl Alcohol (PVA) Serving as the backbone of this bioplastic, PVA is a synthetic polymer known for its excellent film-forming, adhesive, and emulsifying properties. It dissolves in water, making the resultant bioplastic water-soluble.

Mannitol: A type of sugar alcohol, Mannitol functions as a plasticizer. It softens the bioplastic, giving it flexibility. Unlike other plasticizers, Mannitol does not compromise the integrity of the plastic, ensuring longevity in its function.

Lignin: As an organic polymer, Lignin offers UV resistance. This is critical for applications that may involve exposure to sunlight, ensuring that the bioplastic does not degrade prematurely under UV radiation.

Carboxymethyl chitosan (CMC): As a derivative of chitosan, it is water-soluble and known for its biodegradability. Additionally, CMC brings antimicrobial properties to the bioplastic, enhancing the material's resistance to microbial degradation.

Nanocrystalline Cellulose (NCC): Extracted from plant matter, NCC particles enhance the mechanical strength of the bioplastic, making it more resilient under stress. It's a vital component for applications requiring robustness without compromising flexibility.

Stearyl Alcohol: This fatty alcohol serves multiple roles. While it ensures a smooth extrusion or molding process, it also interacts with other components to modify the bioplastic's texture, imparting a smoother finish.

Lactic Acid Apart from adjusting the pH sensitivity, Lactic Acid can also contribute to the biodegradation process. Its presence can make the bioplastic more amenable to decomposition in varied environmental conditions.

Ferulic Acid: A plant-based antioxidant, Ferulic Acid not only provides an added UV shield but also wards off oxidative degradation. This ensures the bioplastic remains stable for a desired period of time even under challenging conditions depending on the quantity ferulic acid in the formula.

According to one aspect of the present invention, the composition comprising:
Polyvinyl alcohol (PVA) 70-80 wt %
Mannitol 8-12 wt %
Lignin 3-6 wt %
Carboxymethyl chitosan (CMC) 5-8 wt %
Nanocrystalline Cellulose (NCC) 2-3 wt %
Stearyl alcohol 3-5 wt %
Lactic Acid 3-5%
Ferulic Acid 0.5-1 wt %.

According to one aspect of the present invention, the production method comprising steps of:
(i) Raw material preparation
(ii) Dry blending
(iii) Wet component addition
(iv) Extrusion
(v) Pelletizing granulation;

and also preferably
(vi) Film formation
(vii) Post-processing
(viii) Quality control
(ix) Packaging and storage.

### BRIEF DESCRIPTION OF THE DRAWINGS

FIG. 1. XRD spectra of water-soluble PVA-based granules.

FIG. 2. DSC thermogram of the granules.

FIG. 3. SEM micrographs of the granules.

FIG. 4. TGA thermogram of the granules.

### DETAILED DESCRIPTION

The present invention pertains to the field of bioplastics, specifically a water-soluble bioplastic (WSBP) composed of polyvinyl alcohol (PVA), carboxymethyl chitosan (CMC), nanocrystalline cellulose (NCC), mannitol, lignin, ferulic acid stearyl alcohol and lactic acid. Furthermore, explains in detail the process of producing this bioplastic material as granules and resulting thin film.

The bioplastic material comprises a unique combination of components, including PVA, mannitol, lignin, carboxymethyl chitosan (CMC), nanocrystalline cellulose (NCC), stearyl alcohol, lactic acid and ferulic acid. The specific ratios of these ingredients have been optimized to achieve a balance between mechanical properties, water solubility, and biodegradability.

| | | | Contribution to Functioning of |
|---|---|---|---|
| Element# | Element Name | Characteristics | Invention |
| 1 | Polyvinyl Alcohol | Water-soluble, | Establishes the primary |
| | (PVA) | biodegradable, and | structure of the bioplastic, |
| | | forms a flexible matrix. | lending it the main set of |
| | | | physical and biodegradable |
| | | | properties |
| 2 | Mannitol | Low hygroscopicity, | Acts as a plasticizer, providing |
| | | good plasticizer | flexibility without adding |
| | | properties, and stable | tackiness. |
| | | up to high | |
| | | temperatures. | |
| 3 | Lignin | Abundant, renewable, | Provides natural UV |
| | | and imparts UV | resistance and enhances |
| | | resistance. | biodegradability. |
| 4 | carboxymethyl | Biocompatible, | Enhances the water-solubility |
| | chitosan (CMC) | biodegradable, and | and biodegradability of the |
| | | can be modified for | bioplastic. |
| | | solubility in water. | |
| 5 | Nanocrystalline | Renewable, imparts | Provides reinforcement, |
| | Cellulose | enhanced mechanical | enhancing the tensile strength |
| | (NCC) | properties. | of the bioplastic. |
| 6 | Lactic Acid | Bio-based, | Promotes flexibility and is a |
| | | biodegradable, and | source of bio-based content. |
| | | can act as a plasticizer. | |
| 7 | Stearyl Alcohol | Long-chain fatty | Aids in processing by acting |
| | | alcohol that acts as an | as a lubricant and ensuring a |
| | | internal lubricant. | smooth, even melt. |
| 8 | Ferulic Acid | Antioxidant properties, | Imparts UV resistance, |
| | | provides UV | making the bioplastic more |
| | | stabilization. | resilient against UV radiation. |

| | Process | |
|---|---|---|
| Step | Step | Explanation |
| i | Raw | All raw materials, including PVA, Mannitol, Lignin, Chitosan |
| | Material | derivative, Lactic Acid, NCC, Stearyl Alcohol, and Ferulic Acid |
| | Preparation | are measured out in their respective amounts and prepared for |
| | | mixing. This may involve sieving, pre-dissolving, or other |
| | | preparation methods. |
| ii | Dry | Dry ingredients, such as PVA, Mannitol, Lignin, NCC, Stearyl |
| | Blending | Alcohol, and Ferulic Acid are initially mixed together in a dry |
| | | state using a high-shear mixer to ensure even distribution. |
| iii | Wet | Lactic Acid and the water-soluble chitosan derivative are |
| | Component | added to the dry mix. This process may involve specific |
| | Addition | temperatures or conditions to ensure that they integrate |
| | | properly with the dry components. |
| iv | Extrusion | The blended mixture is then fed into an extruder, where it is |
| | | subjected to heat and mechanical mixing. This phase melts |
| | | and thoroughly blends the ingredients into a homogenous |
| | | matrix. Adjust temperature settings and screw speed based on |
| | | prior discussion to prevent burning or degradation. |
| v | Pelletizing | The extruded material is cut into small pellets or granules, |
| | Granulation | which can then be used for subsequent processing like film |
| | | casting or molding. |
| vi | Film | Using a film casting machine, the granules can be melted and |
| | Formation | shaped into thin films. This process may involve blowing or |
| | (if desired) | tentering, depending on the machine type. Ensure controlled |
| | | cooling to avoid brittleness or warping. |
| vii | Post- | This could involve steps like UV treatment (to enhance the |
| | processing | properties imparted by Ferulic Acid), cutting, stamping, or any |
| | (if required) | other modifications to the bioplastic to suit its end use. |
| viii | Quality | The final bioplastic or film undergoes quality control tests to |
| | Control | measure its tensile strength, biodegradability, UV resistance, |
| | | water-solubility, and other properties. |
| ix | Packaging | Depending on its intended use, the bioplastic is then packaged |
| | and | appropriately (like in moisture-proof bags if water-solubility is a |
| | Storage | concern) and stored for distribution or further use. |

Polyvinyl alcohol (PVA) 70-80 wt %: Serving as the backbone of this bioplastic, PVA is a synthetic polymer known for its excellent film-forming, adhesive, and emulsifying properties. It dissolves in water, making the resultant bioplastic water-soluble.

Mannitol 8-12 wt %: A type of sugar alcohol, Mannitol functions as a plasticizer. It softens the bioplastic, giving it flexibility. Unlike other plasticizers, Mannitol does not compromise the integrity of the plastic, ensuring longevity in its function.

Lignin 3-6 wt %: As an organic polymer, Lignin offers UV resistance. This is critical for applications that may involve exposure to sunlight, ensuring that the bioplastic does not degrade prematurely under UV radiation.

Carboxymethyl chitosan (CMC) 5-8 wt %: As a derivative of chitosan, it is water-soluble and known for its biodegradability. Additionally, CMC brings antimicrobial properties to the bioplastic, enhancing the material's resistance to microbial degradation.

Nanocrystalline Cellulose (NCC) 2-3 wt %: Extracted from plant matter, NCC particles enhance the mechanical strength of the bioplastic, making it more resilient under stress. It's a vital component for applications requiring robustness without compromising flexibility.

Stearyl alcohol 3-5 wt %: This fatty alcohol serves multiple roles. While it ensures a smooth extrusion or molding process, it also interacts with other components to modify the bioplastic's texture, imparting a smoother finish.

Lactic Acid 3-5%: Apart from adjusting the pH sensitivity, Lactic Acid can also contribute to the biodegradation process. Its presence can make the bioplastic more amenable to decomposition in varied environmental conditions.

Ferulic Acid 0.5-1 wt %: A plant-based antioxidant, Ferulic Acid not only provides an added UV shield but also wards off oxidative degradation. This ensures the bioplastic remains stable for a desired period of time even under challenging conditions depending on the quantity ferulic acid in the formula.

The novel features and enhancements over existing devices or processes in this bioplastic are paramount. By amalgamating Polyvinyl Alcohol (PVA), Mannitol, and Lactic Acid, the bioplastic showcases a pioneering capability to customize its dissolution rate, a trait rarely observed in traditional bioplastics. Many bioplastics grapple with achieving the right equilibrium between resilience and pliability. However, the incorporation of Nanocrystalline Cellulose (NCC) and Mannitol in this formula ensures an ideal balance. Another novel characteristic is its enhanced resistance to UV and oxidative stresses, thanks to the synergistic effects of Lignin and Ferulic Acid. The bioplastic is further fortified with antimicrobial attributes due to the integration of Carboxymethyl chitosan, a quality amplifying its applicability, particularly in scenarios demanding microbial resistance. Furthermore, its decomposition stands out as environmentally benign. With most ingredients hailing from natural origins, the bioplastic decomposes without leaving hazardous by-products, positioning it as a truly green alternative to many prevailing bioplastics.

### Granule Preparation Procedure Using Extrusion

This procedure explains in detail the use of a twin-screw extruder with 12 temperature-controlled zones. The optimized temperature settings and feed rates are based on the specific properties of the materials used and the desired properties of the final granules.

### Preparation

All the components need to be dried to remove any moisture that could affect the process. The drying temperature should be below the melting point of the lowest melting component, typically around 60° C. for several hours.

### Extrusion Process

Feeding: The extrusion process begins with feeding the dry blend of components into the main feeder of the extruder.

Extrusion: In order to extrude, the material is allowed to move through the screws mixing and melting the components. The mechanical action, combined with the set temperatures, will result in a homogeneous melt.

### Pelletizing:

### Temperature Profile:

There are 12 temperature zones each one responsible for a particular job explained in detail as follows:
Zone 1 (Feed Zone): the temperature is set to 50° C. to prevent premature melting.
Zone 2-4 (Conveying and Compression Zones): the temperature is gradually increased from 60° C. to 90° C. to ensure consistent conveying.
Zone 5-7 (Melting Zones): the temperature is set between 120° C. to 140° C. where the PVA starts to melt and mix with the additives.
Zone 8-10 (Mixing and Homogenization Zones): the temperature is increased to 150° C. to ensure thorough mixing and homogenization of the melt.
Zone 11 (Metering Zone): the temperature is maintained at 160° C. to prepare the homogeneous melt for extrusion.
Zone 12 (Die Zone): the final temperature is set at 170° C. to ensure a smooth flow through the die.

### Post-Processing

After the material exits the die, it is cooled down in a conveyor belt to remove any surface moisture and later, it is cut into granules using a granulation device called, the granulator.

### Characterization of Water-Soluble Bioplastic Granules:

A comprehensive characterization of the novel water-soluble bioplastic granules has been carried out. The detailed analysis provided herein, substantiates the unique properties of these granules, which are critical to their functionality and environmental compatibility. The characterization of the PVA-based granules encompasses a series of structural and morphological and analytical techniques namely X-ray diffraction, differential scanning calorimetry, scanning electron microscopy, and thermogravimetric analysis each of which contributing to a holistic understanding of the granules' structural, thermal and morphological characteristics.

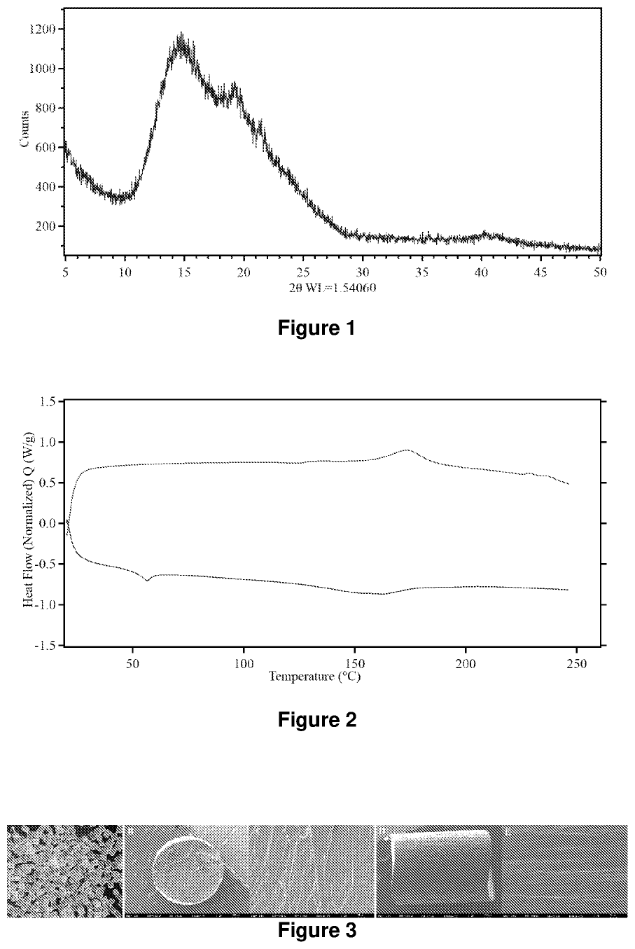

X-ray Diffraction: XRD was employed to determine the crystalline structure of the PVA-based water-soluble granules (FIG. 1). The sharp and narrow peaks typically indicate well-formed, large crystals, whereas broader peaks are indicative of smaller crystallite sizes or increased strain in the crystal lattice. For Polyvinyl Alcohol (PVA), the broad peak at around 20=10-25° is indicative of its semi-crystalline to amorphous structure. In the context of PVA-based composites, this broad peak is typical and suggests that the material has a significant amorphous phase, which is consistent with the flexible and water-soluble nature of PVA. The components like mannitol, carboxymethyl chitosan, and nanocrystalline cellulose may also contribute to this broad feature. The presence and characteristics of these features in the spectra can be significantly influenced by the water solubility of the granules. Water molecules can disrupt the regular packing of PVA chains, leading to alterations in peak intensities and shapes. Some sharp peaks would be indicative of well-defined crystalline structures within the material. The fluctuations in intensity at higher angles (2θ>25) may be due to the presence of different constituents in the granules, each with its own crystalline or semi-crystalline nature.

Differential Scanning calorimetry (DSC): DSC test results for your PVA-based granules provide valuable information about their thermal properties. The glass transition temperature (Tg) at 53.83° C. indicates when the PVA-based granules transition from a hard and relatively brittle state into a more rubbery and flexible state takes place. A Tg in this range suggests some flexibility at slightly elevated temperatures, which is typical for semi-crystalline polymers like PVA. The melting temperature (Tm) at 153.75° C. is the temperature at which the crystalline regions of the PVA and possibly other semi-crystalline additives within the granules start melting. The presence of a distinct melting peak suggests that there are crystalline domains within the material presenting a semi-crystalline structure. A melting temperature in this range also indicates the material would have good thermal stability up to this point. The melting enthalpy (ΔHm) of 10.31 J/g quantifies the heat required to melt the crystalline regions per gram of material. The magnitude of this value indicates a moderate degree of crystallinity within the granules. Moreover, the crystallization temperature (Tc) at 95.97° C. on cooling, is the temperature at which the material transitions from the liquid or rubbery state returns back to a semi-crystalline solid, as the polymer chains align to form crystalline structures. The fact that this temperature is significantly lower than the melting temperature suggests a supercooling effect, which is common in polymers. Finally, the crystallization enthalpy (ΔHc) of 9.79 J/g represents the heat released during crystallization per gram of the material. This is a relatively high value, suggesting that the material has a significant ability to crystallize upon cooling, which can be important for processing and end-use properties. The presence of both melting and crystallization peaks with significant enthalpies indicates that the material is semi-crystalline. The relatively high temperatures for both transitions suggest that the granules would maintain their shape and not melt or deform at temperatures encountered during normal use, up to at least 95.97° C. The difference between the melting enthalpy and crystallization enthalpy can also suggest some degree of irreversibility in the crystalline structure due to processing or the presence of other components in the blend. These results indicate that the granules have a good balance between flexibility and structural integrity, making them suitable for applications where temperature resistance and mechanical strength are important. Additionally, the moderate Tg ensures that at room temperature, the material is solid but can become more pliable at slightly elevated temperatures, which could be beneficial for processing methods such as extrusion or molding.

TABLE 1
The results of DCS analysis of the granules

| | Result |
|---|---|
| Glass Transition Temperature (° C.) | 53.83 |
| Melting Temperature (° C.) | 153.75 |
| Melting Enthalpy (J/g) | 10.31 |
| Crystallization Temperature (° C.) | 95.97 |
| Crystallization Enthalpy (J/g) | 9.79 |

FIG. 2. shows the DSC thermogram of the granules. The red curve represents the heating phase where we observe an endothermic peak at around 153.75° C., which corresponds to the melting temperature, Tm, of the granules. The absence of any significant peaks or transitions between the glass transition and the melting point suggests a stable thermal behavior in this range. The green curve represents the cooling stage in which the lack of significant exothermic peaks suggests that crystallization is not pronounced upon cooling signaling a high degree of amorphous content. The abrupt changes in the baseline at the beginning of the cooling course could be due to experimental factors such as changes in the DSC settings or thermal lag, or they could represent physical degradation or a thermal event beyond the typical operating range of the polymer.

Scanning Electron Microscopy (SEM): SEM analysis of the granules (FIG. 3.) provided detailed imagery at the microscale, allowing us to observe the surface morphology and particle size distribution of the granules. Such morphological characteristics are key factors in determining the dissolution rate and overall performance of the bioplastic in practical applications. Image A is a normal photo taken to provide a clear view of the water-soluble PVA granules.

Micrograph B shows a PVA granule with a relatively rough surface, possibly indicating porosity or a particular type of processing that the granules have undergone. The cracks and lines on the surface might suggest brittleness or stress within the material. The rough surface could also be due to the presence of fillers or other additives in the PVA matrix. In micrograph C, we can see striations and grooves along the surface. These features could be a result of mechanical processing, such as cutting or milling. The presence of such features often affects the mechanical properties of the granules, such as their ability to bond or melt together during processing. Micrograph D displays a cross-section of the PVA-based granule, showing a relatively smooth interior compared to the surface. This indicates that the surface roughness might be a result of a post-processing treatment or the granule's interaction with the environment. The uniformity of the interior is a good sign, suggesting consistent material properties throughout the granule. At a similar magnification to the previous images, micrograph E shows a smoother surface texture with minimal striations or grooves. This surface could be representative of a different batch or a different area of the granules that underwent a distinct processing step or less mechanical stress.

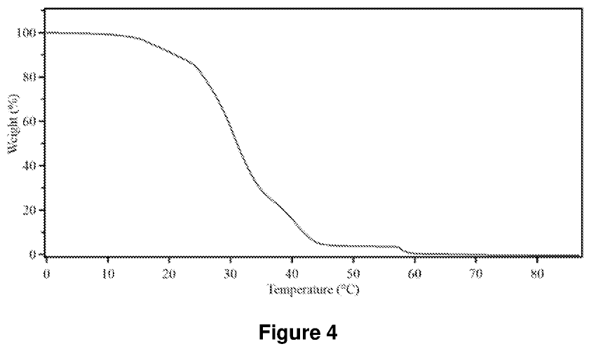

Thermogravimetric Analysis (TGA): The TGA data of the PVA-based granules presents several distinct stages of thermal degradation and pyrolysis, each indicating different processes occurring within the material as the temperature increases (Table 2). The first degradation stage with a minor weight loss of 2.84% at 65-181° C. likely corresponds to the evaporation of water or other volatile components in the granules. The temperature range suggests the removal of bound or adsorbed moisture, which is common in hydrophilic materials like PVA. The graph (FIG. 4.) shows a very gentle slope in this temperature range, indicating a slow and steady weight loss. This aligns with the 2.84% weight loss noted in the table, which could be due to the evaporation of water or other volatile components absorbed in the PVA granules.

The second degradation stage starting at 181-268° C. and a weight loss of 11.70% represents the absence of a clear maximum degradation temperature in this stage suggesting a more gradual breakdown process being attributed to the beginning of the decomposition of organic components, possibly including the degradation of additives like mannitol, lactic acid, or the water-soluble chitosan derivative. In the graph, the slope becomes steeper after 181° C., corresponding to an increased rate of weight loss. This phase, accounting for 11.70% weight loss, likely represents the beginning of thermal decomposition of the material, potentially involving the loss of additives or low molecular weight polymer chains.

The third degradation stage shows a significant loss of 61.97% at 268 to 400° C. 61.97% weight loss is indicative of the main thermal decomposition of the PVA polymer backbone. The maximum degradation temperature at 332° C. aligns with the expected range for PVA decomposition, which involves breaking down of the polymer chains and loss of structural integrity. In this range, the graph shows a very steep slope, indicative of a rapid weight loss. This major weight loss of 61.97% corresponds to the breakdown of the main PVA polymer chains. The maximum degradation temperature at 332° C. suggests this is the temperature at which the material's rate of decomposition is highest, which is typically associated with the most substantial structural breakdown.

The fourth degradation stage at 400-510° C. and the weight loss of 20.11% may represent further breakdown of the residual components, potentially including lignin and any remaining complex organic structures. The temperature peak at 434° C. suggests a more rapid degradation process, possibly due to the decomposition of more thermally stable components. As the temperature increases beyond 400° C., there is another notable decline in weight, though less steep than the previous stage. The weight loss of 20.11% with a maximum degradation temperature at 434° C. suggests further breakdown of any residual organic material or decomposition of more thermally stable components.

Pyrolysis is the 5th stage at which a small weight reduction of 3.42% occurs at 565 to 625° C. which might be attributed to the pyrolysis of any remaining organic materials. The low ash content of 0.13% indicates a high degree of material breakdown and conversion to volatile products. As seen in the graph, the weight decreases slowly once again, indicating pyrolysis of the remaining material beyond 565° C. This results in a final weight loss of 3.42%, leaving behind an ash content of 0.13%. The flat line towards the end of the graph indicates that no significant mass change occurs beyond this temperature range, suggesting the completion of thermal degradation.

Overall, the TGA data reveals a multi-stage degradation behavior typical of composite materials containing a blend of polymers and additives. The significant weight loss at higher temperatures demonstrates the effective thermal decomposition of the PVA-based granules, while the low residual ash content indicates minimal inorganic residue, which is is advantageous for applications where environmental impact and biodegradability are concerns.

TABLE 2
The result of TGA analysis of the granules

| | | Granules |
|---|---|---|
| 1. Degradation | Weigh (%) | 2.84 |
| | Initial-Final Temperature (° C.) | 65-181 |
| | Maximum Degradation Temperature | — |
| | (° C.) | |
| 2. Degradation | Weigh (%) | 11.70 |
| | Initial-Final Temperature (° C.) | 181-268 |
| | Maximum Degradation Temperature | I |
| | (° C.) | |
| 3. Degradation | Weigh (%) | 61.97 |
| | Initial-Final Temperature (° C.) | 268-400 |
| | Maximum Degradation Temperature | 332 |
| | (° C.) | |
| 4. Degradation | Weigh (%) | 20.11 |
| | Initial-Final Temperature (° C.) | 400-510 |
| | Maximum Degradation Temperature | 434 |
| | (° C.) | |
| 5. Pyrolysis | Weigh (%) | 3.42 |
| | Initial-Final Temperature (° C.) | 565-625 |
| | Ash Content (%) | 0.13 |

The findings from these comprehensive analyses not only validate the innovative nature of the PVA-based bioplastic granules but also provide a scientific basis for their potential applications. The following subsections detail the methodology and results of each characterization technique, elucidating how each property aligns with the granules' intended applications and environmental benefits.

Polyvinyl alcohol (PVA) acts as mary polymer matrix for structure. Water-soluble, film-forming properties allow for cohesive matrix formation and inherent biodegradability.

Mannitol imparts flexibility by spacing polymer chains, reducing intermolecular forces, thus decreasing brittleness.

Lignin acts as UV stabilizer and strength enhancer and Natural polymer that absorbs UV rays, preventing degradation; improves mechanical strength by cross-linking.

Carboxymethyl chitosan (CMC) helps with biodegradability and antimicrobial properties. Its bioactive nature allows for microbial degradation; inherent antimicrobial property adds hygiene factor.

Nanocrystalline Cellulose (NCC) provides large surface area for interaction with PVA, enhancing tensile strength and rigidity.

Stearyl alcohol facilitates smooth and even melt and processing during extrusion, reducing manufacturing complications.

Lactic acid accelerates polymer degradation in microbial environments; regulates pH to ensure stability during processing.

Ferulic acid scavenges free radicals, preventing oxidative degradation; absorbs UV rays for protection.

The production method within the scope of the invention includes the following process steps in its most basic form:
Dry mixing of all ingredients ensures uniform dispersion of components in the absence of water;
Hot extrusion process guarantees homogenous mixing of the ingredients;
Granulation of extruded material produces granules for ease of further processing and thin film production;
UV stabilization with ferulic acid imparts UV resistance to the bioplastic, extending its outdoor usability;
Final quality control using spectroscopy ensures consistency in the bioplastic properties, specifically the UV resistance.

Raw Material Storage: There should be separate bins or storage containers for each raw material-PVA, Mannitol, Lignin, Chitosan derivative, Lactic Acid, NCC, Stearyl Alcohol, and Ferulic Acid. These should be labeled and easily accessible to the mixing area.

Mixing Area: This should have the high-shear mixer for dry blending and subsequent wet component addition. Ideally, this area would be separated from the storage to avoid cross-contamination.

Extrusion Line: Following the mixing area, the blended material should feed into the extruder. This area should have temperature and speed controls, as well as safety features in case of clogs or jams.

Pelletizing Section: Just after the extruder, there should be machinery to cut and form the extruded material into granules or pellets.

Film Casting (optional): This would be a separate section, possibly in a clean room environment if high-quality, uncontaminated films are desired.

Post-processing Area: Here, any further modifications like UV treatment or stamping can occur. There should be stations or machinery dedicated to each post-process task.

Quality Control Lab: A dedicated space where the produced bioplastic undergoes various tests. This should be equipped with tensile strength measuring equipment, UV test chambers, solubility test setups, etc.

Packaging and Storage: A final section where the approved product is packaged and prepared for shipment or storage. This area should have packaging materials, sealing machines, and storage racks or containers.

Waste Management: It's important to have a designated section or procedure to handle waste, especially since this is an environmentally-focused product. Any off-spec product or process waste should be managed in an eco-friendly manner.

The proposed bioplastic formula emphasizes sustainability by prioritizing components sourced from renewable resources, effectively reducing fossil fuel reliance and the associated carbon footprint. Notably, the bioplastic boasts versatility; its primary application may be for thin films, but potential extensions include coatings and encapsulations based on processing adjustments. Drawing from natural and bio-based sources, the ingredients ensure a favorable safety profile, minimizing environmental and health hazards during manufacturing and the post-consumer phase. A distinctive advantage is the bioplastic's water-solubility, presenting an alternative disposal method that facilitates degradation in aquatic habitats and addresses the escalating plastic waste crisis in water bodies. There's also an intriguing possibility of synergistic effects; the constituents' interplay might offer properties that surpass the mere sum of individual components, potentially boosting mechanical or barrier traits.

Furthermore, commercial viability is front and center. While environmental advantages are paramount, economic feasibility isn't overlooked. The ingredient selection reflects a balance between performance and cost-effectiveness. Serving as a foundational blueprint, the formula leaves room for future enhancements, be it through integrating emerging ingredients or processing methods as bioplastic research progresses. It also offers flexibility, with opportunities to blend with other polymers or additives for tailored properties and to tweak processing conditions for diverse product features. The market potential is promising; given the global tilt towards sustainable solutions, this formulation is poised to resonate with a burgeoning segment of environmentally-aware consumers and industries scouting for eco-friendly alternatives. As always, diving deeper into each facet can yield richer insights based on detailed research, rigorous trials, and empirical manufacturing and testing data.

The water-soluble bioplastic material presented in this invention can find a wide range of potential applications spanning various industries. In the food packaging sector, this novel formulation can serve as wrappings for disposable items offering single-use packaging solutions for snacks as well as providing edible packaging alternatives. The agricultural sector can harness its unique properties for the creation of dissolvable mulch films, paving the way for the controlled release of nutrients or pesticides, and as temporary protective layers for plants. In the medical field, WSBP presents an opportunity for biocompatible and dissolvable packaging for medical supplies and can act as temporary vessels for medical specimens. E-commerce platforms can adopt it as a sustainable packaging alternative for shipped goods, allowing the material to dissolve post-use and substantially reducing shipping waste. Its application can extend to consumer goods as well, providing eco-friendly packaging solutions for everyday household items, personal care products, and other commodities that commonly rely on single-use plastics. Furthermore, in waste management, the current invention can revolutionize the design of shopping bags or containers tailored for specific disposal processes, including composting and bio-degradation. Additionally, an exciting application of the bioplastic granules lies in the domain of homecare products. These granules, when processed into thin films, emerge as an excellent choice for packaging laundry detergent gel packs, combining ease-of-use with eco-consciousness, ensuring consumers enjoy an efficient wash cycle without the environmental concerns of conventional plastic waste.

Packaging: As a water-soluble and environmentally friendly bioplastic, it can be used as an alternative to traditional plastics in food packaging, especially for single-use items as well as thin film processing for application in detergent gel packaging used in washing and dishwashing machines.

Agriculture: This bioplastic could be used for creating water-soluble seed tapes or pods, which would dissolve when exposed to moisture, releasing seeds into the soil.

Medical Field: Potential for use in drug delivery systems, especially where controlled dissolution or biodegradability is needed.

Environmental Cleanup: Given its water-solubility, it might be used in applications where temporary structures (e.g., barriers or nets) that can dissolve in water are needed.

1. A high-tensile temperature-adjustable solubility bioplastic granules composition comprising:
polyvinyl alcohol (PVA);
carboxymethyl chitosan (CMC);
nanocrystalline cellulose (NCC);
mannitol;
lignin;
ferulic acid;
stearyl alcohol; and
lactic acid.

2. The bioplastic granules composition of claim 1, wherein components are present in the following wt %:
Polyvinyl alcohol (PVA) 70-80 wt %;
Mannitol 8-12 wt %;
Lignin 3-6 wt %;
Carboxymethyl chitosan (CMC) 5-8 wt %;
Nanocrystalline Cellulose (NCC) 2-3 wt %;
Stearyl alcohol 3-5 wt %;
Lactic Acid 3-5%; and
Ferulic Acid 0.5-1 wt %.

3. A method to produce high-tensile temperature-adjustable solubility bioplastic granules comprising the production steps of:
(i) Raw material preparation;
(ii) Dry blending;
(iii) Wet component addition;
(iv) Extrusion; and
(v) Pelletizing granulation.

4. The method of claim 3, further comprising a production step of:
(vi) Film formation.

5. The method of claim 3, wherein further comprising a production step of:
(vii) Post-processing.

6. The method of claim 3, further comprising a production step of:
(viii) Quality control.

7. The method of claim 3, further comprising a production step of:
(ix) Packaging and storage.

8. The method of claim 3, wherein the raw materials in the production step of (i) comprise raw materials of:
polyvinyl alcohol (PVA);
carboxymethyl chitosan (CMC);
nanocrystalline cellulose (NCC);
mannitol;
lignin;
ferulic acid;
stearyl alcohol; and
lactic acid.

9. The method of claim 8, wherein the raw materials are present in the following wt %:
Polyvinyl alcohol (PVA) 70-80 wt %;
Mannitol 8-12 wt %;
Lignin 3-6 wt %;
Carboxymethyl chitosan (CMC) 5-8 wt %;
Nanocrystalline Cellulose (NCC) 2-3 wt %;
Stearyl alcohol 3-5 wt %;
Lactic Acid 3-5%; and
Ferulic Acid 0.5-1 wt %.
